(19) United States
(12) Patent Application Publication
(10) Pub. No.: US 2011/0021140 A1
(43) Pub. Date: Jan. 27, 2011

(54) METHOD AND APPARATUS FOR PROVIDING HOME HEALTHCARE SERVICES USING A SENSOR NETWORK

(75) Inventor: Richard Binier, Versailles (FR)

Correspondence Address: DITTHAVONG MORI & STEINER, P.C., 918 Prince Street, Alexandria, VA, 22314, US

(73) Assignee: Boston Life Labs, Wilmington, DE (US)

(21) Appl. No.: 12/841,635

(22) Filed: Jul. 22, 2010

Related U.S. Application Data
(60) Provisional application No. 61/227,685, filed on Jul. 22, 2009.

(51) Int. Cl. H04B 5/00

(52) U.S. Cl. 455/41.1

(57) ABSTRACT

An approach is provided for home healthcare services using a sensor network. An apparatus detects an initialization of at least one dongle, the dongle configured to initiate pairing of the apparatus to at least one sensor. The apparatus identifies the at least one sensor based, at least in part, on the pairing, and initiates collection of data via the at least one sensor based, at least in part, on the identification.

### RELATED APPLICATIONS

This application claims the benefit of the earlier filing date under 35 U.S.C. §119(e) of U.S. Provisional Application Ser. No. 61/227,685 filed Jul. 22, 2009, entitled “Method and Apparatus for Providing Home Healthcare Services Using a Sensor Network,” the entirety of which is incorporated herein by reference.

### BACKGROUND

Historically, it is recognized that providing healthcare services, particularly home healthcare services, is a labor intensive and costly endeavor. Accordingly, healthcare providers and manufacturers of related healthcare products are challenged to develop innovative solutions to make such services more efficient. One area of development involves integrating advances in telecommunications and electronic sensor technology to collect, report, and distribute of health and other related data. Traditionally, such integration can be complicated and require extensive technical knowledge to implement and use on a routine basis, thereby discouraging the adoption of automated sensor technology for use in, for instance, home healthcare.

### SOME EXAMPLE EMBODIMENTS

Therefore, there is a need for an approach for efficiently managing a network of automated sensors while providing ease of use.

According to another embodiment, an apparatus comprising at least one processor, and at least one memory including computer program code for one or more computer programs, the at least one memory and the computer program code configured to, with the at least one processor, cause the apparatus to detect an initialization of at least one dongle. The dongle configured to initiate pairing of the apparatus to at least one sensor. The apparatus is also caused to identify the at least one sensor based, at least in part, on the pairing. The apparatus is further caused to initiate collection of data via the at least one sensor based, at least in part, on the identification.

According to one embodiment, a method comprises detecting an initialization of at least one dongle. The dongle configured to initiate pairing of an apparatus to at least one sensor. The method also comprises identifying the at least one sensor based, at least in part, on the pairing. The method further comprises initiating collection of data via the at least one sensor based, at least in part, on the identification.

According to another embodiment, a computer-readable storage medium carrying one or more sequences of one or more instructions which, when executed by one or more processors, cause an apparatus to detect an initialization of at least one dongle. The dongle configured to initiate pairing of the apparatus to at least one sensor. The apparatus is also caused to identify the at least one sensor based, at least in part, on the pairing. The apparatus is further caused to initiate collection of data via the at least one sensor based, at least in part, on the identification.

According yet to another embodiment, an apparatus comprises means for detecting an initialization of at least one dongle. The dongle configured to initiate pairing of an apparatus to at least one sensor. The apparatus also comprises means for identifying the at least one sensor based, at least in part, on the pairing. The apparatus further comprises means for initiating collection of data via the at least one sensor based, at least in part, on the identification.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a communication system capable of managing a sensor network, according to an exemplary embodiment;

FIG. 2 is a diagram of components of a sensor hub, according to an exemplary embodiment;

FIG. 3 is a diagram of components of a sensor backend platform, according to an exemplary embodiment;

FIG. 4 is a diagram of a dongle and a corresponding sensor, according to an exemplary embodiment;

FIG. 5 is a flowchart of a process for initiating data collection from a sensor connected to a sensor hub, according to an exemplary embodiment;

FIG. 6 is a flowchart of a process for initiating data collection at a sensor backend platform, according to an exemplary embodiment;

FIG. 7 is a flowchart of a process for authenticating a user to access sensor data, according to an exemplary embodiment;

FIGS. 8A-8C are diagrams of user interfaces displayed on a portable display utilized in the processes of FIGS. 5-7, according to various exemplary embodiments;

FIGS. 9A and 9B are diagrams of user interfaces displayed on a web portal utilized in the processes of FIGS. 5-7, according to various exemplary embodiments;

FIG. 10 is a diagram of a sample use case for using a sensor hub to remotely program a sensor, according to an exemplary embodiment;

FIG. 11 is a diagram of a sample use case for using a personal emergency response system (e.g., life alert) sensor connected to a sensor hub, according to an exemplary embodiment; and

FIG. 12 is a diagram of hardware that can be used to implement an embodiment of the invention.

### DESCRIPTION OF PREFERRED EMBODIMENT

An apparatus, method, and software for providing a sensor network are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Although various embodiments of the invention are described with respect to healthcare services and certain communication technologies, it is contemplated that the sensor network has applicability to other services (e.g., alarms, monitoring, etc.) and equivalent technologies.

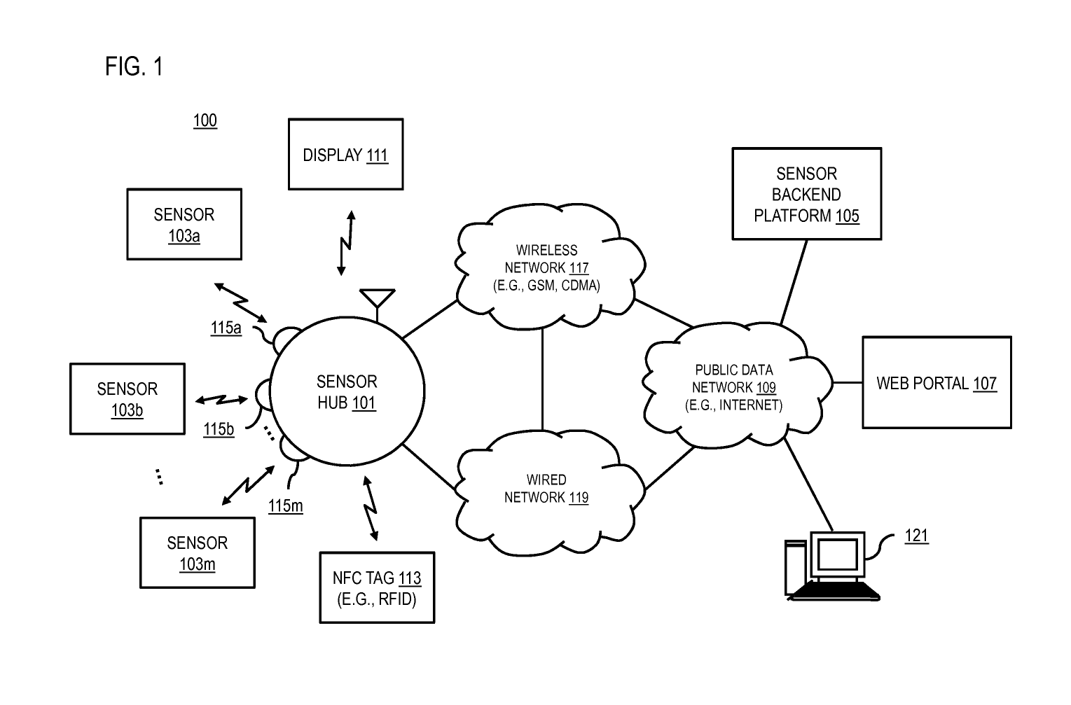

FIG. 1 is a diagram of a communication system capable of managing a sensor network, according to an exemplary embodiment. As discussed previously, a significant portion of the healthcare costs and labor go to acquiring data or testing patients with respect to various medical parameters (e.g., blood pressure, pulse, weight, temperature, glucose level, blood oxygen level, etc.). When a patient is treated in the home (e.g., home nursing or hospice care), healthcare professionals (e.g., nurses and doctors) often must make frequent visits to collect this information, which can result in substantial costs. Moreover, because of limited labor or availability of healthcare professionals, testing in some circumstances may be curtailed to a minimum level, resulting in a less complete picture of the patient's health.

To address this problem, the approach described herein leverages electronic sensors and communications technologies to provide a system 100 including a sensor hub 101 with connectivity to a family of wireless enabled devices and sensors (e.g., sensors 103a-103m; also collectively referred to as sensors 103) for collecting health-related (e.g., medical parameters and status) and other environmental data (e.g., smoke detectors, carbon monoxide (CO) detectors, movement sensors, etc.). Through this automated approach, patients can be monitored more frequently with less cost than with conventional approaches. In addition, the sensor hub 101 is linked to a sensor backend platform 105 that offers access to collected sensor data via a web portal 107 to the patient and other authorized users (e.g., doctors, nurses, other caregivers, family members, etc.) over a public data network 109 (e.g., the Internet). The patient may also access collected sensor information or other sensor backend platform 105 functions via a wireless display 111 connected (e.g., via Bluetooth) to the sensor hub 101. The sensor hub 101 may also be used to identify authorized users via a near field communication (NFC) tag 113 (e.g., radio frequency identification (RFID) tag, contactless card, or similar technology) associated with the user.

In one embodiment, the public data network 109 enables the sensor backend platform 105 to connect to or provide a variety of related services. For example, the sensor backend platform 105 may be automatically configured to bill appropriate health accounts (e.g., insurance, Medicare, social aid, etc.) for tests conducted or services performed. In another example, the public data network 109 may facilitate two-way communication (e.g., voice, text messaging, E-mail, media file sharing, etc.) between the patient and a doctor, nurse, or caregiver through the sensor hub 101. In another example, the sensor hub 101 may facilitate tracking of authorized caregivers via NFC tags 113. For instance, when a caregiver enters a patient's home to provide a service to the patient, the caregiver may log into an electronic timesheet application available over the sensor hub 101 by placing the caregiver's NFC tag 113 on or near the sensor hub 101 for reading. The caregiver can then access any of the sensors 103 or data available through the sensor hub 101 (e.g., via the wireless display) to record check points, relevant information on the patient's health and wellness, and/or completed services.

The specific monitored parameters and/or available functions are determined by the type of sensors 103a-103m installed at the sensor hub 101. According to certain embodiments, to maintain ease of use, the system 100 of FIG. 1 employs dongles 115a-115m that are automatically associated with their corresponding sensors and/or devices 103a-103m to offer a plug and play experience when adding or changing sensors 103a-103m. For example, a dongle 115 includes authentication information (e.g., sensor or device identification number and password) to enable the sensor hub 101 to automatically pair and communicate with a sensor or device 103 corresponding to the dongle 115 via, for instance, short range radio such as Bluetooth, WiFi, or other similar radio frequency protocol. In one example use case, to monitor patient weight, the user plugs a dongle 115 corresponding to a wireless enabled scale into the sensor hub 101. On detecting the dongle 115, the sensor hub 101 retrieves the authentication information stored in the dongle 115 to automatically initiate pairing with the associated wireless scale. The patient does not need to perform any other action, other than plugging the dongle 115 into the sensor hub 101, to initiate pairing with a sensor or device 103, thereby advantageously reducing the need to perform a traditional complex pairing procedure. As the patient uses the scale, the sensor hub 101 collects and transmits the patient's weight to the sensor backend platform 105 for storage and access. The same installation process can be performed to activate any of a variety of sensors 103a-103m (e.g., health or environmental) compatible with the sensor hub 101.

As shown in FIG. 1, the sensor hub 101 has connectivity to the public data network 109 over either a wireless network 117 and/or a wired network 119. By way of example, the wireless network 117 may be a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wireless fidelity (WiFi), satellite, mobile ad-hoc network (MANET), and the like. The wired network 119 may be, for instance, any local area network (LAN), metropolitan area network (MAN), wide area network (WAN), or any other suitable packet-switched network, such as a commercially owned, proprietary packet-switched network, e.g., a proprietary cable or fiber-optic network.

In one embodiment, the sensor hub 101 is by default configured to operate over the wireless network 117. The wireless network 117 enables connectivity to the sensor backend platform 105 even when the patient does not have separate Internet capabilities installed at the patient's home. If the patient's home does have Internet capabilities (e.g., wired network 119), the sensor hub 101 may be connected to the wired network 119 for access to the sensor backend platform 105. In certain embodiments, the sensor hub 101 may connect to both the wireless network 117 and the wired network 119 to provided redundant network access in case either the wireless network 117 or the wired network 119 is not available.

By way of example, the sensor hub 101 communicates with the sensors/devices 103a-103m, the sensor backend platform 105, and other network components (e.g., the terminal 121, display 111, or web portal 107) using standard protocols. In this context, a protocol includes a set of rules defining how the network nodes within the system of FIG. 1 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination/address, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

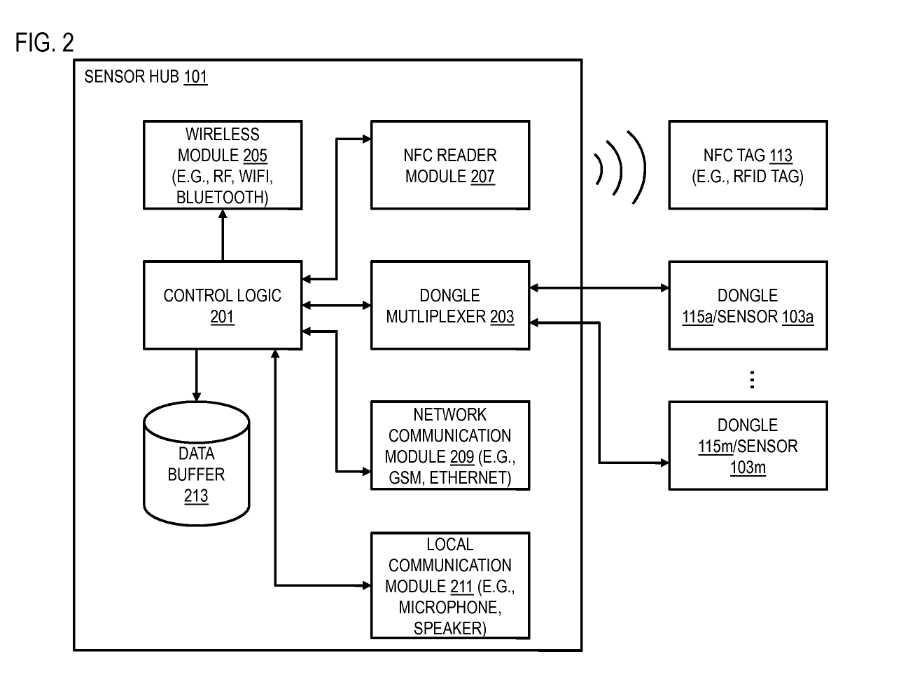

FIG. 2 is a diagram of components of a sensor hub 101, according to an exemplary embodiment. The sensor hub 101, for instance, enables easy plug and play installation of sensors and/or devices 103a-103m. The sensor hub 101 also facilitates management of the flow of data in and out of the sensor hub 101 to the sensor backend platform 105. As shown, the sensor hub 101 includes several modules and components to manage a network of, for instance, medical and environmental sensors. It is contemplated that the functions of the modules and components may be combined or performed by other components or logic of the system of FIG. 1. In one embodiment, the sensor hub 101 includes a control logic 201, dongle multiplexer 203, wireless module 205, NFC reader 207, network communication module 209, local communication module 211, and data buffer 213. The control logic 201 may, for instance, interact with the dongle multiplexer 203 to detect when a dongle 115/sensor 103 pair has been inserted into the sensor hub 101. The insertion of the dongle 115 then causes the control logic 201 to direct the wireless module 205 to pair and communicate with the sensor 103 corresponding to the attached dongle 115. The wireless module 205 supports a variety of short range communication protocols such as Bluetooth, WiFi, and other similar radio frequency (RF) protocols.

In one embodiment, the wireless module 205 employs communication protocols of varying ranges (e.g., 10 meters or 100 meters) to create concentric rings of connectivity with attached sensors and devices 103a-103m. By way of example, the sensor hub 101 is typically installed at the center of a sensor network to maximize range. Bluetooth may be used to communicate with sensors and devices 103a-103m within close proximity to the sensor hub 101, while WiFi may be used to communicate with sensors and devices 103a-103m located farther from the sensor hub 101. Communication with the sensors/devices 103a-103m support, for instance, identification and configuration of the sensors/devices 103a-103m and collection of data from the sensors/devices 103a-103m.

With respect to sensor configuration and data collection, the control logic 201 interacts with the network communication module 209 to communicate with the sensor backend platform 105 over either the wireless network 117 or the wired network 119 to access the public data network 109. The network communication module 209 can support any number of wireless communication protocols (e.g., cellular protocols) such as GSM, CDMA, etc., to enable the sensor hub 101 to communicate with the sensor backend platform 105 without needing to maintain or rely on a separate data (e.g., Internet) connection in the patient's home. The control logic 201, for instance, stores the data collected from the sensors 103a-103m in a data buffer 213 for transmission to the sensor backend platform 105. In certain embodiments, sensor hub 101 may transmit the data immediately without local storage. In either case, the transmission can occur over an encrypted transmission to protect the privacy of the sensor data.

In one embodiment, the sensor hub 101 also enables direct voice two-way communication session between the sensor backend platform 105 and the sensor hub 101. In this way, a party connected to the sensor backend platform 105 (e.g., doctor, nurse, caregiver) can speak directly to the patient via a speaker included in the local communication module 211. The local communication module 211 also includes a microphone to enable the patient or other party located near the sensor hub 101 to respond. For example, on accessing a patient's sensor data, a doctor may use the two-way communication function of the local communication module 211 to ask the patient a follow-up question or otherwise communicate with the patient. In another embodiment, the two-way voice communication function may be provided over the cellular connection of the wireless network 117. In this way, the party speaking to the user of the sensor hub 101 need not be connected to the sensor backend platform 105.

In addition, the sensor hub 101 includes an NFC reader module 207 to read NFC tags 113 associated with authorized caregivers and service providers. In one embodiment, the patient and/or other authorized caregivers may access the functions of the sensor hub 101 by authenticating access using an NFC tag 113. More specifically, the NFC reader module 207, initiates reading of an NFC tag 113 associated with a user when the NFC tag 113 is brought in close proximity to the reader. In certain embodiments, the NFC reader module 207 is a component of the sensor hub 101. In other embodiments, the NFC reader module 207 is an external peripheral attached to the sensor hub 101.

By way of example, NFC, RFID, contactless card, and similar technologies are short-range wireless communication technologies that enable the exchange of data between devices over short distances (e.g., the range for NFC is approximately 4 inches). In general, these technologies comprise two main components, a tag (e.g., attached to an object) and a reader (which can be implemented within the sensor hub 101). Communication between the reader and the tags occur wirelessly and may not require a line of sight between the devices. The tag (e.g., an RFID transponder) is, for instance, a small microchip that is attached to an antenna. The tags can vary in sizes, shapes, and forms and can be read through many types of materials. Moreover, the tags may be passive tags or active tags. Passive tags are generally smaller, lighter, and less expensive than active tags. Passive tags are only activated when with the response range of a reader. The reader emits a low-power radio wave field that is used to power the tag so as to pass on any information that is contained on the chip. Active tags differ in that they incorporate their own power source to transmit rather than reflect radio frequency signals. Accordingly, active tags enable a broader range of functionality like programmable and read/write capabilities.

A reader typically contains a transmitter, receiver, control unit, and an antenna. The reader performs three primary functions: energizing the tag, demodulating and decoding the returned radio signal. In certain embodiments, a reader includes an additional interface to convert the returned radio signal to a form that can be passed to another system such as a computer or programmable logic controller.

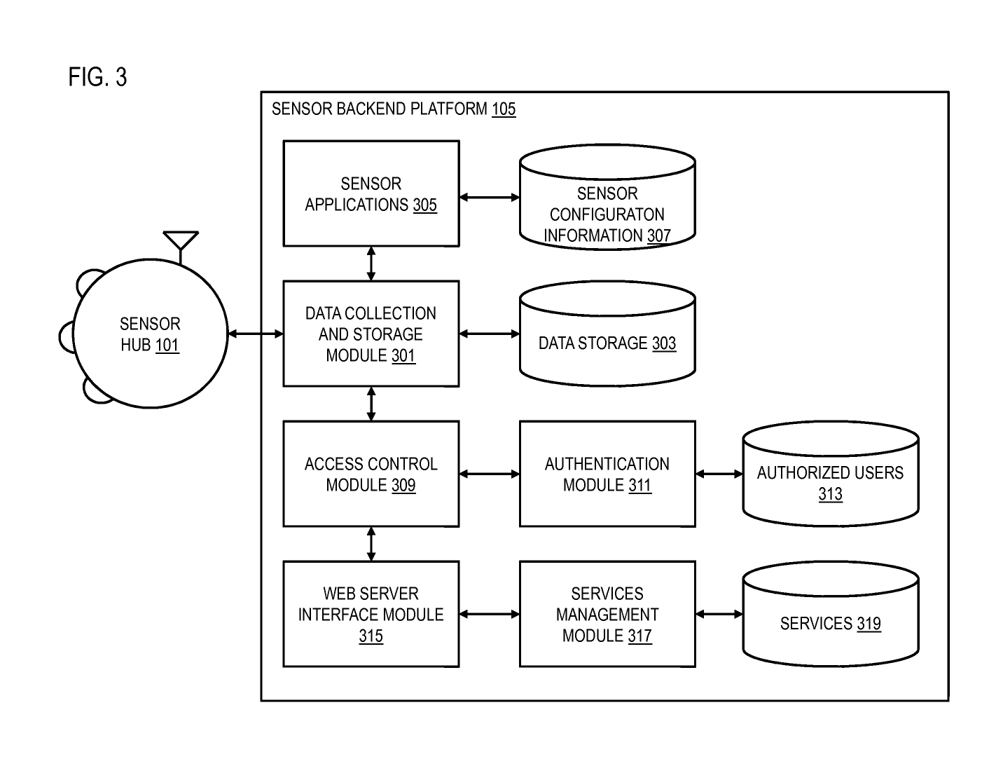

FIG. 3 is a diagram of components of a sensor backend platform 105, according to an exemplary embodiment. The sensor backend platform 105 is, for instance, a component attached to the public data network 109 to collect and store data transmitted from the sensor hub 101, control the configuration of the sensors 103a-103m attached to the sensor hub 101, provide access to a web portal 107 interface, and interface with related services (e.g., health account payments, etc.). As shown, the sensor backend platform 105 includes several modules and components to perform the functions discussed above. It is contemplated that the functions of the modules and components may be combined or performed by other components or logic of the system of FIG. 1. In one embodiment, the sensor backend platform 105 includes a data collection and storage module 301, data storage 303, sensor applications 305, database 307 of sensor configuration information, access control module 309, authentication module 311, database 313 of authorized users, web server interface module 315, services management module 317, and database 319 of services.

The data collection and storage module 301 receives data from the sensors 103a-103m attached to the sensor hub 101 and stores the data in the data storage 303 database. In addition, the data collection and storage module 301 receives requests from the sensor hub 101 for sensor configuration information (e.g., frequency of monitoring, type of monitoring, billing information, etc.). The data collection and storage module 301 interacts with the corresponding sensor application 305 to determine the configuration information from the database 307 of sensor configuration information. The sensor configuration information may be specified, for instance, by the patient or other authorized user (e.g., doctor, nurse, caregiver). In addition, the sensor configuration information may also be set by default.

Access to the data storage 303 of sensor data is controlled by the access control module 309. The access control module 309, for instance, stores a list of authorized users and their corresponding access credentials and levels of access. The access credentials (e.g., user identification/password combination, NFC tag) are used by the authentication module 311 to ensure that only authorized users have access to the sensor data and/or the functions of the sensor hub 101 and sensor backend platform 105. It is contemplated that the authentication module 311 may use any mechanism (e.g., biometric security, address filtering, etc.) to authenticate users. In one embodiment, differing levels of access permit certain users access only to certain sensor data. The access level also may dictate when and through what mechanism (e.g., two-way voice communication directly to the sensor hub 101) a user may communicate with the patient. For example, family members may be given access to view vital statistics and to also send photos and other files to the patient through the sensor hub 101. On the other hand, a doctor may be granted full access to program and configure sensors and devices 103a-103m attached to the sensor hub 101.

As shown, the sensor backend platform 105 includes a web server interface module 315 to enable authorized users to access the sensor backend platform 105 through the web portal 107. The web server interface module 315 provides access to the sensor data and functions of the sensor hub 101 and sensor backend platform 105. In one embodiment, the functions include the services provided by the services management module 317. The services management module 317 enables the configuration of additional services related to the sensors 103a-103m (e.g., account payment and billing, personal emergency response system (PERS), caregiver time tracking, etc.). The specific services provided by the services management module 317 can be configured by the patient or other authorized user.

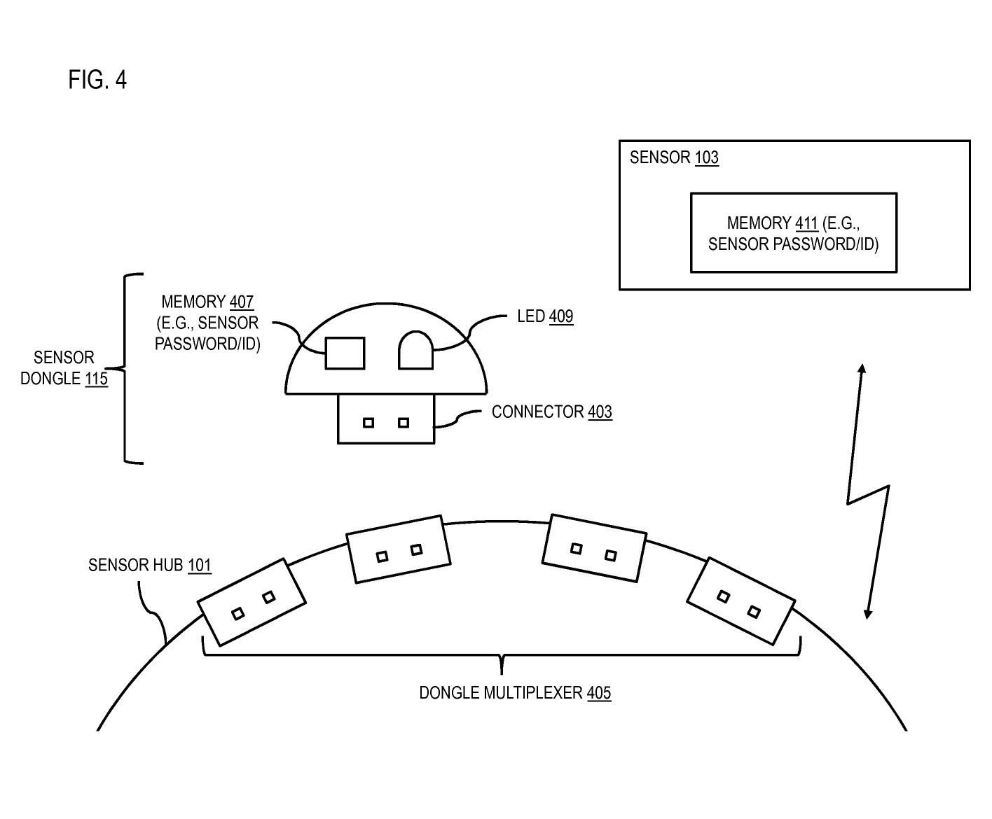

FIG. 4 is a diagram of a dongle 115 and a corresponding sensor 103, according to an exemplary embodiment. As previously described, pairing of each sensor or device 103 with the sensor hub 101 is initiated by plugging (e.g., via connector 403) a dongle 115 corresponding to the sensor or device 103 into the sensor hub 101. In one embodiment, the dongle 115 is connected to the sensor hub 101 via a universal serial bus (USB) connection through the dongle multiplexer 405 containing a number of connections (e.g., 12 USB ports) to support multiple sensors and devices 103a-103m. It is contemplated that any other similar connection (e.g., IEEE 1394 interface, PCMCIA, PC Express, and the like) may also be used to connect the dongle 115 to the sensor hub 101. The dongle 115 enables the plug and play automatic pairing of devices and sensors 103a-103m with the sensor hub 101. Each dongle 115 includes a memory 407 and a light emitting diode (LED) 409 or other equivalent status indicator (e.g., a liquid crystal display (LCD) display). For example, the LED 409 indicates the pairing status with the corresponding device or sensor 103. In one embodiment, the LED 409 flashes slowly to indicate that the corresponding sensor 103 is in use and flashes quickly to indicate a malfunction, initialization, or other state of the sensor 103. The password and device ID or other pairing authentication information associated with the device/sensor is stored in the dongle memory 407. Similarly, each sensor 103 includes a memory 411, which also stores the password and device ID associated with the device/sensor 103. As a result, plugging the dongle 115 into the sensor hub 101, for instance, immediately triggers a search and automatic pairing of the sensor/device 103 by the wireless module 205 of the sensor hub 101.

In one embodiment, the sensors and/or devices 103a-103m available to connect to the sensor hub 101 may include health (e.g., medical) sensors/devices and environmental sensors/devices. For example, health sensors include a blood pressure meter, pulse meter, scale, thermometer, glucometer, oxymeter, spirometer, and other similar sensors. Environmental sensors include, for instance, smoke detectors, CO detectors, and internal and external temperature sensors. Environmental sensors may also be used to detect basic user activity such as opening a refrigerator, entering the bathroom, movement and activity in particular rooms of the patient's house, fall detectors, etc. Data from the sensors 103a-103m can be read wirelessly from the sensors 103a-103m and transmitted (e.g., pushed) to the sensor backend platform 105 over either the wireless network 117 or the wired network 119.

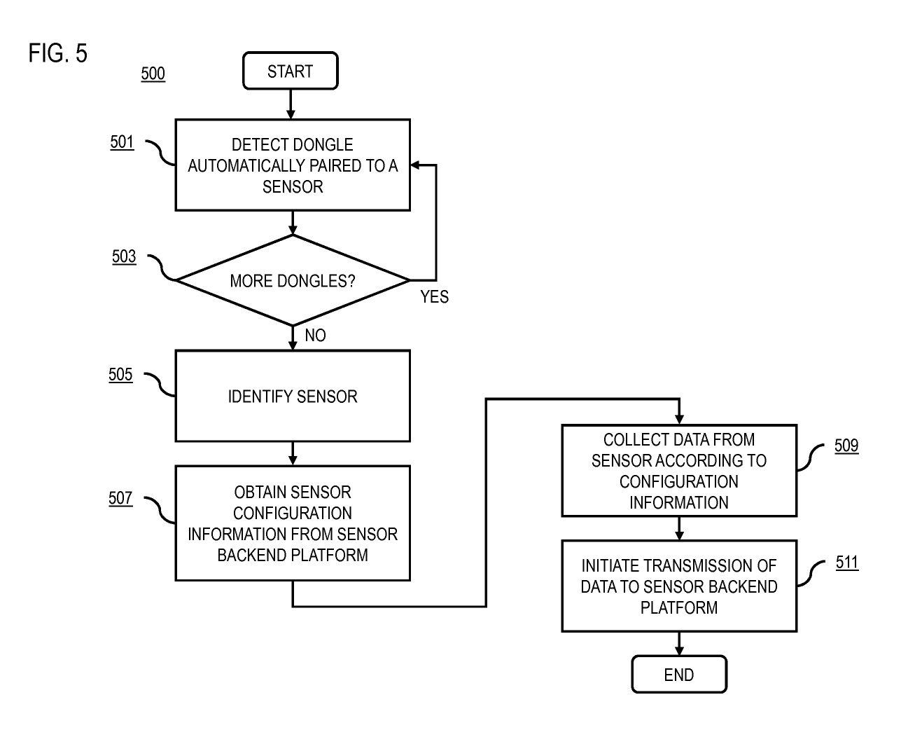

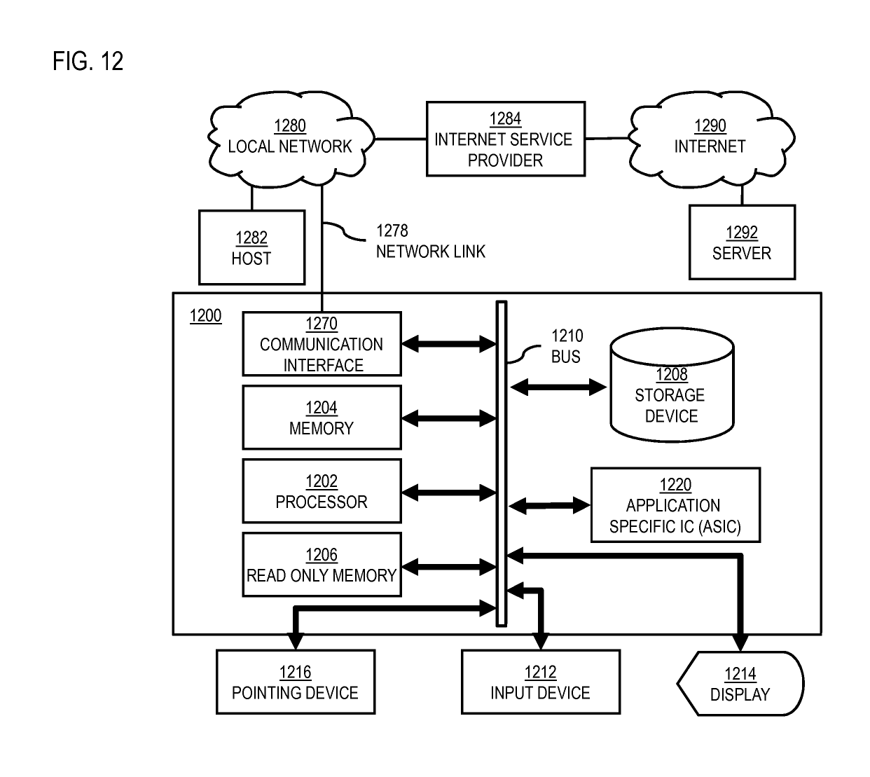

FIG. 5 is a flowchart of a process for initiating data collection from a sensor connected to a sensor hub 101, according to an exemplary embodiment. In one embodiment, the sensor hub 101 performs the process 500 and is implemented in, for instance, a chip set including a processor and a memory as shown in FIG. 12. On initialization, connection, or changing a sensor, the sensor hub 101, in step 501, detects the inserting of a dongle 115 into a port of the sensor hub 101. As discussed above, the dongle 115 initiates automatic pairing of its corresponding sensor or device 103 with the sensor hub 101. In step 503, the sensor hub 101 continues to detect any additional dongles 115a-115m that have been newly installed in the sensor hub 101 until all connected dongles 115a-115m have been detected and all corresponding sensors and/or devices 103a-103m have been paired.

Based on the detected sensor or sensors 103a-103m, the sensor hub 101, in step 505, identifies the sensor 103 by, for instance, retrieving a unique device identifier and comparing the identifier against a device lookup table. In one embodiment, the device lookup table may be resident in either the sensor hub 101 or the sensor backend platform 105. In addition or alternatively, the sensor 103 may transmit identifying information (e.g., device name, manufacturer, model number, etc.) to the sensor hub 101 on connection. The sensor hub 101 then, in step 507, obtains sensor configuration information from the sensor backend platform 105 to initiate data collection. The configuration information includes, for instance, frequency, type, and duration of data collection. In certain embodiments, the configuration information may also include device drivers to enable the sensor hub 101 to control the functions of the sensor or device 103.

After configuration, the sensor hub 101, in step 509, begins collecting data from the sensor 103 according to the configuration information. The sensor hub 101 then, in step 511, initiates transmission of the sensor data to the sensor backend platform 105 for storage and processing. As discussed previously, the sensor hub 101 may either store the sensor data in a data buffer 213 before transmitting to the sensor backend platform 105 or transmit (e.g., push) the data directly to the sensor backend platform 105 for immediate storage. In one embodiment, the sensor hub 101 transmits the data in encrypted format to protect the privacy of the information.

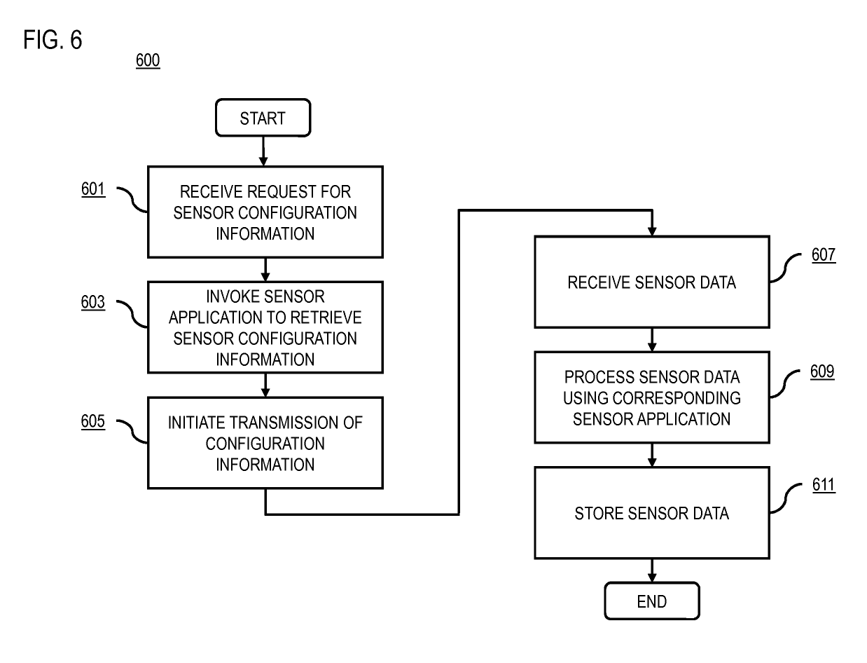

FIG. 6 is a flowchart of a process for initiating data collection at a sensor backend platform, according to an exemplary embodiment. In one embodiment, the sensor backend platform 105 performs the process 600 and is implemented in, for instance, a chip set including a processor and a memory as shown in FIG. 12. To initiate data collection at the sensor backend platform 105, the platform, per step 601, receives a request for sensor configuration information from the sensor hub 101. The request can be received in response to, for instance, installation or modification of a dongle 115/sensor 103 pair at the sensor hub 101. In response to the request, the sensor backend platform 105, for instance in step 603, invokes a sensor application 305 corresponding to the request to retrieve the configuration information. If there is no previously stored configuration information, the sensor backend platform 105 may request that the patient or other authorized user enter the configuration information. This configuration information controls how the corresponding sensor or device 103 operates and reports its data.

The sensor backend platform 105, in step 605, initiates transmission of the configuration information to the sensor hub 101 and, in step 607, begins receiving sensor data accordingly. In certain embodiments, the sensor backend platform 105, as in step 609, can use a corresponding sensor application 305 to process the collected sensor data. For example, a sensor application 305 corresponding to a blood pressure sensor may be configured to alert a doctor if blood pressure exceeds a predetermined level. In another example, a family member may be alerted if no movement is detected for a predetermined period of time. After processing the received sensor data, the sensor backend platform 105, in step 611, stores the data for future access.

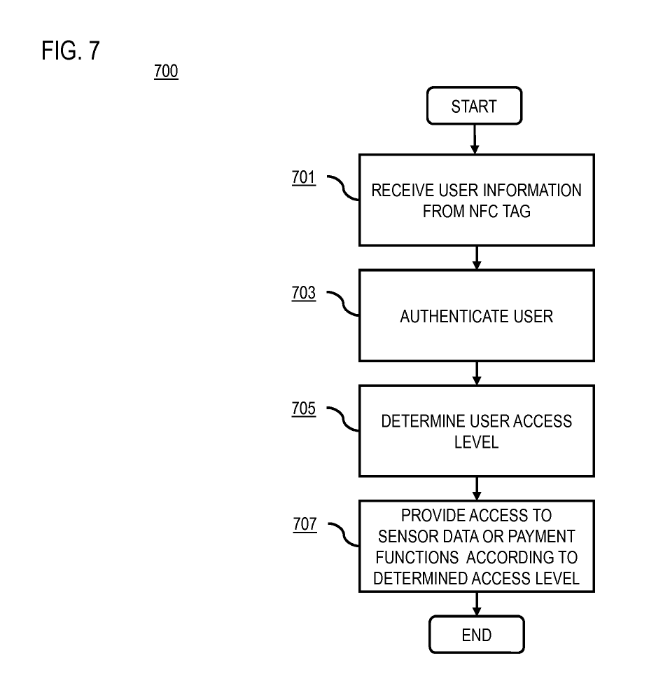

FIG. 7 is a flowchart of a process for authenticating a user to access sensor data, according to an exemplary embodiment. In one embodiment, the sensor backend platform 105 performs the process 700 and is implemented in, for instance, a chip set including a processor and a memory as shown in FIG. 12. In other embodiments, the sensor hub 101 can perform the process 700. NFC (e.g., RFID) is used to control access to sensor data and related functions. NFC can also be used to control and administer the authorization, efficiency, and payment of nursing and caregiving services, as well as any other payment of home services paid or reimbursed by a third party. Third party funding services are usually governmental or state institutions, insurance policies, savings, social aid funds, and/or home healthcare funds (private or public). In one embodiment, third parties load authorized reimbursement funds into the sensor hub 101 or sensor backend platform 105. External service providers (e.g., caregivers, nurses, repair services, home maintenance services, cleaning services, etc.) can place their respective NFC tags 113 near the server hub 101 to identify their company or service, employee identification number, and to record completion of requested services. The user will be able to authorize the service and payment for the service via the sensor hub 101. In some cases (e.g., when the user is impaired), an authorized user can authorized services and payments on behalf of the patient. For example, this authorization can be provided remotely using the web portal 107.

As shown in FIG. 7, the sensor backend platform 105 or sensor hub 101, in step 701, receives user information read from an NFC tag 113. The sensor backend platform 105 then, in step 703, authenticates whether the user can access the sensor hub 101 or the sensor backend platform 105 by determining, per step 705, a predetermined level of access granted to the user. For example, a doctor may be granted full access to control the operation of attached sensors and devices 103a-103m; and a repair man may be granted access only to log repair activity and request payment.

Following the determination of access level, the sensor backend platform 105, in step 707, provides access to the sensor data or payment functions corresponding to the authorized level of access. For example, the user can review health graphs such blood pressure and weight. The user can also grant access to medical teams to monitor and review medical or physical vital signs collected over time. These medical teams may also monitor and operate medical devices (e.g., feeding pumps) as needed.

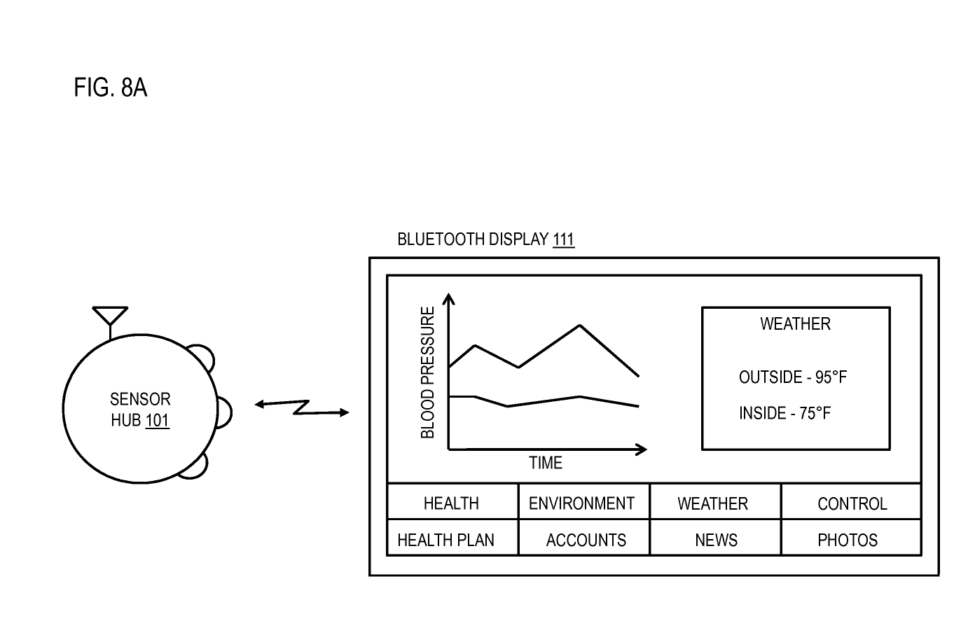

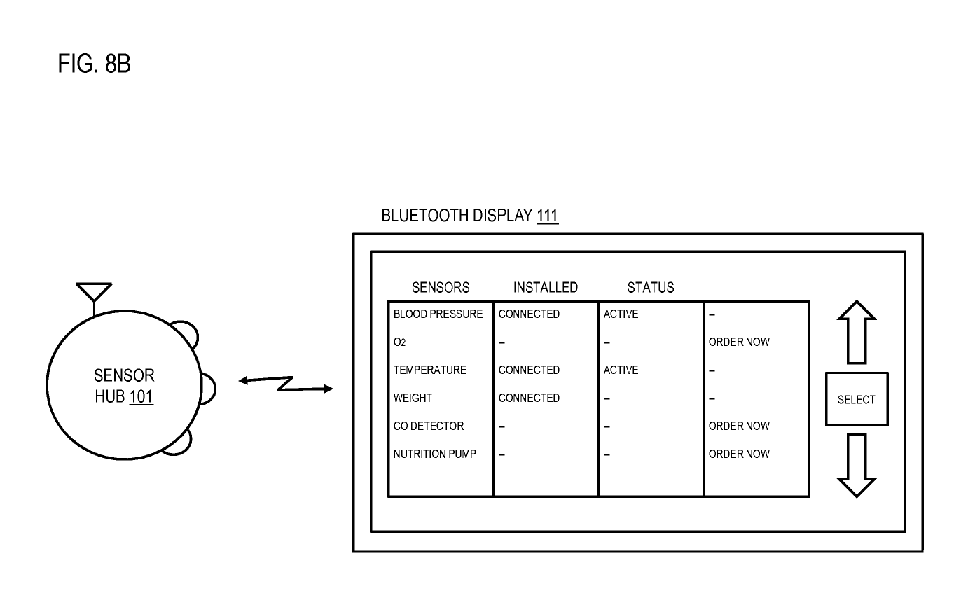

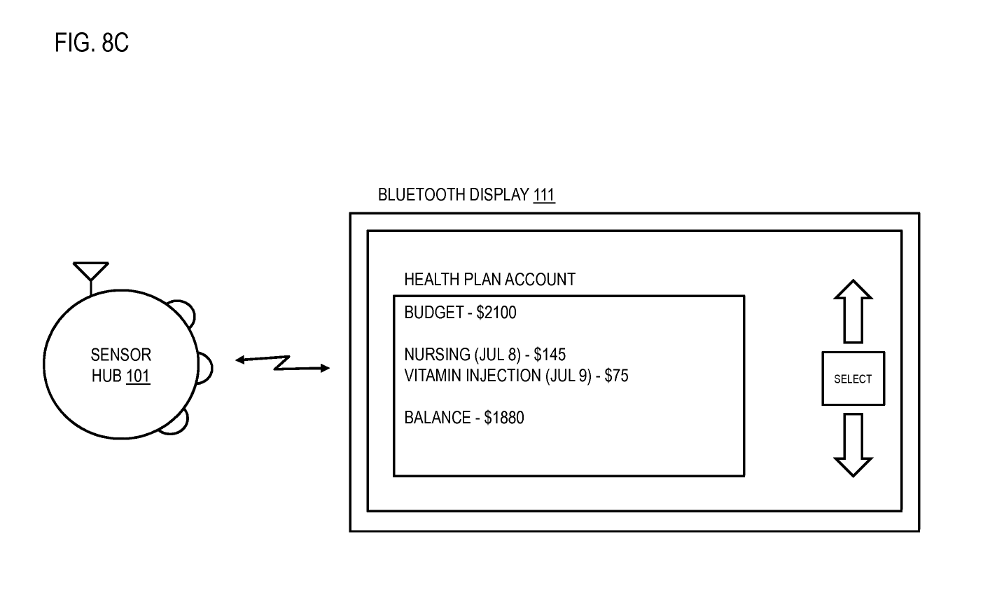

FIGS. 8A-8C are diagrams of user interfaces displayed on a portable display utilized in the processes of FIGS. 5-7, according to various exemplary embodiments. FIG. 8A depicts an optional wireless (e.g., Bluetooth) display 111 for presenting the functions of and information collected by the sensor hub 101, according to an exemplary embodiment. This portable screen replicates the information and functions of the sensor hub 101 and sensor backend platform 105 available over the web portal 107. The display 111, for instance, is used to bypass and avoid having to access the Internet to view relevant data collected by the sensor hub 101. In certain embodiments, the display 111 may also present other information such as news, weather, photos, etc. As shown in FIG. 8A, the display 111 is presenting a graph of the patient's blood pressure monitored over time, as well as the determined indoor and outdoor temperatures. Through this display 111, the user may also access menus to show other vital sign graphs or data, as well as access health plans, accounts, and other controls.

FIG. 8B depicts a user interface screen showing the status of available sensors and devices, according to an exemplary embodiment. As shown, the user interface of FIG. 8B presents a list of sensors 103a-103m, their installation status (e.g., connected or not), and operational status (e.g., active). The display 111 lists, for example, all sensors 103a-103m that have been attached to the sensor hub 101 with respect to a particular patient. The user is also presented with an option to order additional sensors 103a-103m. In this example, any sensor 103 that is not currently owned by the user includes an option to “order now.” The sensor status screen may also be accessed via the web portal 107.

FIG. 8C depicts a user interface screen of the status of a user's health plan account, according to an exemplary embodiment. As discussed previously, the sensor hub 101 may assist the user in managing the balances of healthcare accounts. In the example of FIG. 8C, the display 111 shows the original budget balance of the health plan account, any deductions from the account (e.g., nursing services and vitamin injection), and the remaining balance. In this way, the user can quickly view the most current balance of the accounts to help manage expenses and deductions from the account. It is contemplated that the sensor hub 101 and sensor backend platform 105 may manage any number of the user's accounts.

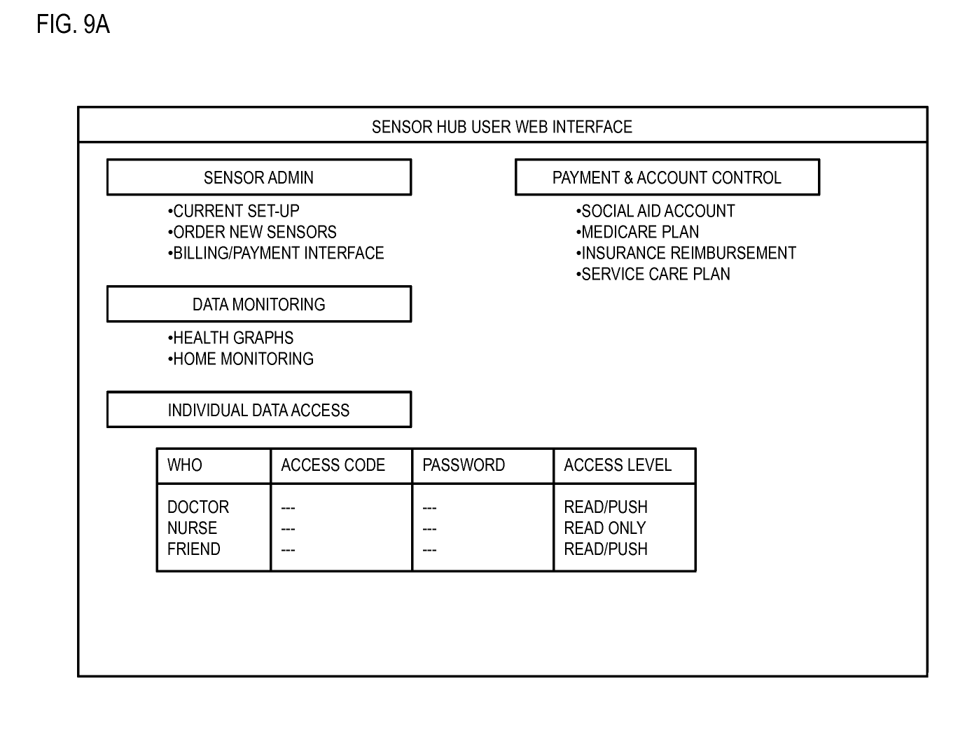

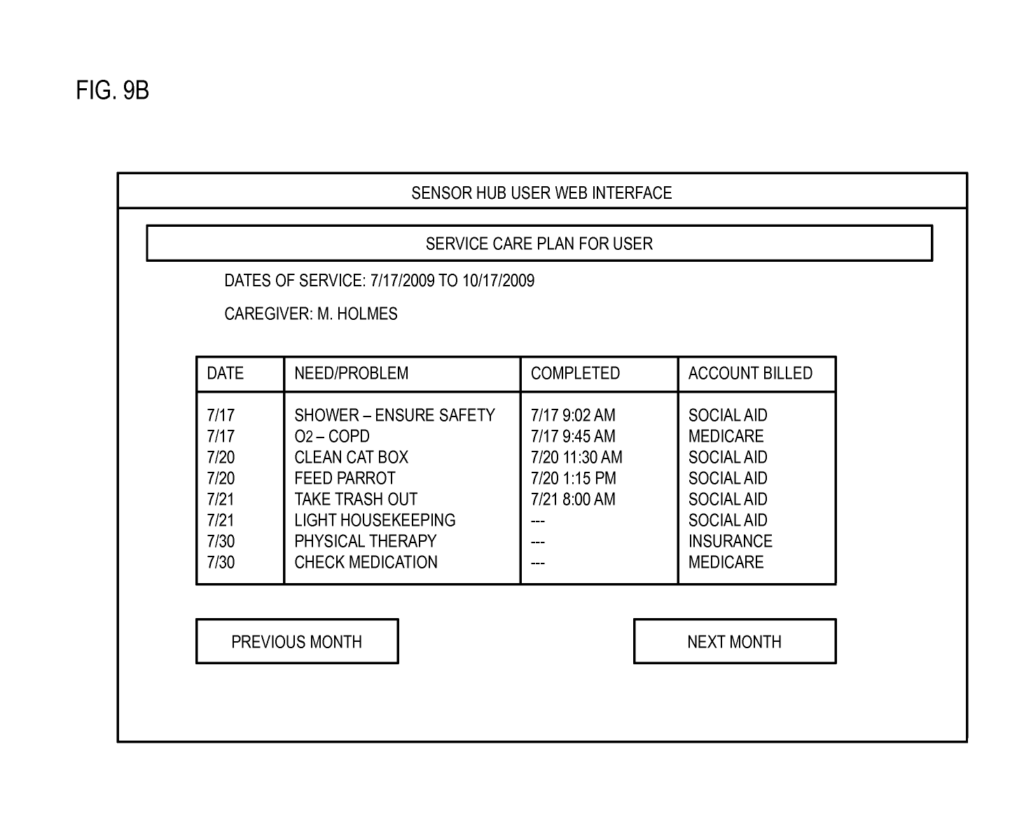

FIGS. 9A and 9B are diagrams of user interfaces displayed on a web portal utilized in the processes of FIGS. 5 and 6, according to various exemplary embodiments. FIG. 9A depicts a general web server interface to the sensor backend platform 105 provided through, for instance, the web portal 107. In the example of FIG. 9A, data is encrypted in the sensor backend platform 105 and stored securely to prevent unauthorized access. This data is proprietary to the user and available to other parties only on authorization of the user. The user interface of FIG. 9A is available only to such authorized users. As shown, the user interface includes controls to: (1) administer connected sensors, e.g., view current set-up, order new sensors, and view billing/payment information; (2) access data monitoring data, e.g., view health graphs, view home monitoring sensors; (3) specify health payment and billing account balances, e.g., social aid account, Medicare plan, insurance reimbursements, and service care plans; and (4) administer individual data access for authorized users.

For example, through the web interface, public or private social and health institutions can remotely credit funds to specific aid plans defined in the sensor backend platform 105. This enables the institutions to tag funds to specific service plans, and avoid potential misuse of aid budgets because the sensor hub 101 securely identifies service providers, tracks service planning and performance, and authorizes payments to service providers. Onsite caregivers (e.g., nurses) may then access an equivalent user interface on the wireless display of the sensor hub 101 to record information (e.g., patient health information, completion status of authorized services, etc.). In addition, through the web interface, authorized family members may send photos, videos, other files onto the screen of the sensor hub 101. The web interface also offers different service packs and running modes to display selected information sources such as news, weather, community messages, text messages, emails, etc. In this way, the user need not have access to the Internet to obtain this information.

FIG. 9B depicts a web interface of a service care plan for a user, according to an exemplary embodiment. The care plan provides a list of activities to be performed by service providers over a period of time. Because the care plan can be preapproved by payment providers (e.g., Medicare, insurance policies, etc.), the user only needs to verify completion of the service activity to authorize payment for the particular activity. The caregiver or service provider can access the service care plan by placing the provider's NFC tag 113 near the sensor hub 101 when the provider enters the home and leaves the home after completing the planned service. The service provider's time schedule is logged in automatically so that the provider can be paid immediately from the funds deposited in the sensor hub after confirmation by the patient or other authorized user.

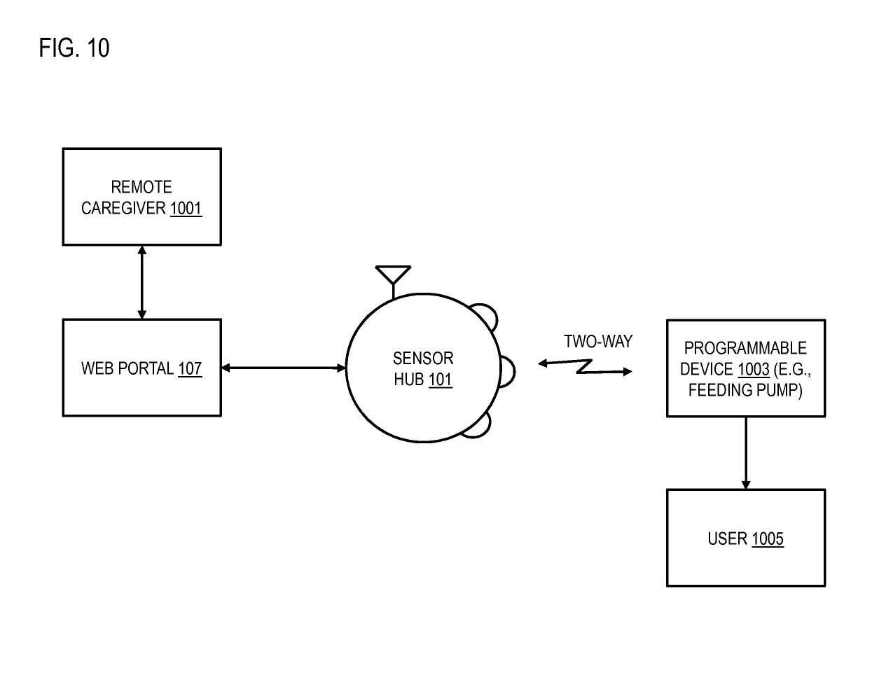

FIG. 10 is a diagram of a sample use case for using a sensor hub to remotely program a sensor, according to an exemplary embodiment. In one embodiment, medical devices or programmable sensors connected to the sensor hub 101 can operate in at least one of two modes: (1) the sensor hub 101 can read and push data on the operation of the device (e.g., a feeding pump) to the sensor backend platform 105 and to authorized medical professionals (e.g., remote caregiver 1001) through the secure web interface provided through the web portal 107; or (2) the authorized medical professionals can monitor and actively control the functioning of the medical programmable device 1003 (e.g., feeding pump) remotely by modifying or reprogramming the medical programmable device 1003 for the user 1005 in response to changed medical conditions or alarms. Distant monitoring of medical devices or programmable sensors attached to the sensor hub 101 is enabled, for instance, by the wireless module 205 (e.g., Bluetooth, WiFi, other similar RF protocols) of the sensor hub 101.

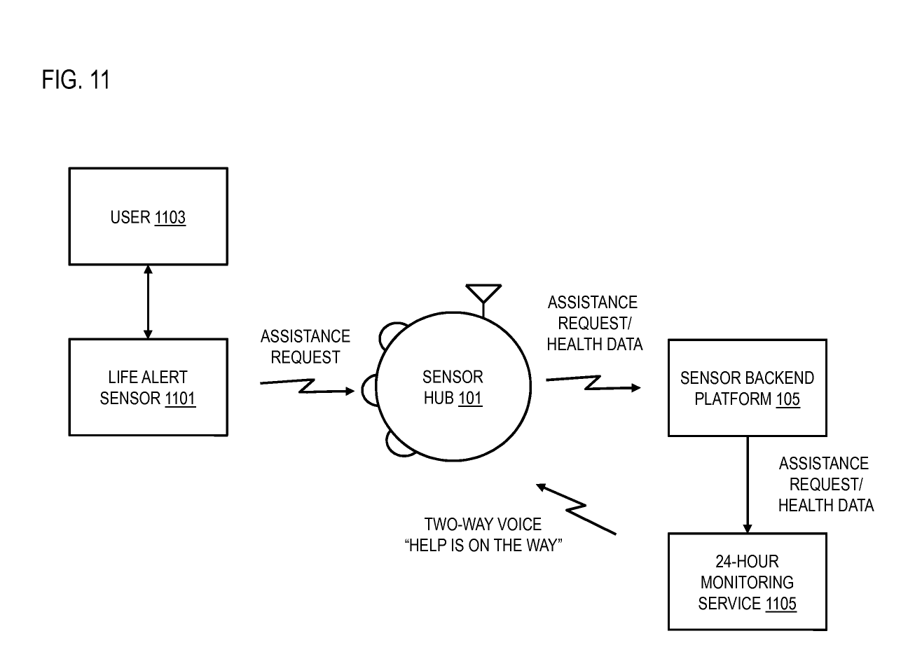

FIG. 11 is a diagram of a sample use case for using a personal emergency response system (e.g., life alert) sensor connected to a sensor hub, according to an exemplary embodiment. The example of FIG. 11 depicts a life alert function for elderly, sick, or isolated patients to use in case of an emergency. By way of example, the life alert may be triggered automatically based on a life alert sensor 1101 or manually by the user 1103. For example, sensors 103a-103m attached to the server hub 101 can be programmed to trigger an emergency call to a 24-hour monitoring service 1105 in case of a detected danger (e.g., high CO levels detected, high internal temperatures during the summer, no use of the refrigerator for 24 hours, etc.). The user 1003 may also trigger the life alert manually by pressing an RF button linked to the sensor hub 101.

In one embodiment, the RF button is provided as a necklace or watch worn by the user and provides instant two-way communication to the assistance center via the wireless connection of the sensor hub 101. More specifically, the user can communicate via the microphone and speaker built into the sensor hub 101. The microphone and speaker are very sensitive and effective even when the user is a considerable distance (e.g., 50 meters or more) away from the sensor hub 101. In addition or alternatively, the user may be provided with a remote microphone and speaker that is, for instance, part of the RF button to effect communication with the assistance center. When a life alert is triggered, all medical data and health vitals stored in the sensor backend platform 105 is immediately delivered to the responding medical emergency teams. In one example, the delivery may be made electronically to a terminal 121 or display 111 belonging to the emergency team. In addition or alternatively, the sensor backend platform 105 may deliver the information as a text message, email, fax, or other like mechanisms to the emergency team. In certain embodiments, the sensor hub 101 may be equipped with an emergency battery back-up system in order to continue functioning in the event of a power outage.

The processes described herein for managing a sensor network may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

FIG. 12 illustrates a computer system 1200 upon which an embodiment of the invention may be implemented. Computer system 1200 is programmed (e.g., via computer program code or instructions) to manage a sensor network as described herein and includes a communication mechanism such as a bus 1210 for passing information between other internal and external components of the computer system 1200. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 1200, or a portion thereof, constitutes a means for performing one or more steps of managing a sensor network.

A bus 1210 includes one or more parallel conductors of information so that information is transferred quickly among devices coupled to the bus 1210. One or more processors 1202 for processing information are coupled with the bus 1210.

A processor 1202 performs a set of operations on information as specified by computer program code related to managing a sensor network. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 1210 and placing information on the bus 1210. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1202, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 1200 also includes a memory 1204 coupled to bus 1210. The memory 1204, such as a random access memory (RAM) or other dynamic storage device, stores information including processor instructions for managing a sensor network. Dynamic memory allows information stored therein to be changed by the computer system 1200. RAM allows a unit of information stored at a location called a memory address to be stored and retrieved independently of information at neighboring addresses. The memory 1204 is also used by the processor 1202 to store temporary values during execution of processor instructions. The computer system 1200 also includes a read only memory (ROM) 1206 or other static storage device coupled to the bus 1210 for storing static information, including instructions, that is not changed by the computer system 1200. Some memory is composed of volatile storage that loses the information stored thereon when power is lost. Also coupled to bus 1210 is a non-volatile (persistent) storage device 1208, such as a magnetic disk, optical disk or flash card, for storing information, including instructions, that persists even when the computer system 1200 is turned off or otherwise loses power.

Information, including instructions for managing a sensor network, is provided to the bus 1210 for use by the processor from an external input device 1212, such as a keyboard containing alphanumeric keys operated by a human user, or a sensor. A sensor detects conditions in its vicinity and transforms those detections into physical expression compatible with the measurable phenomenon used to represent information in computer system 1200. Other external devices coupled to bus 1210, used primarily for interacting with humans, include a display device 1214, such as a cathode ray tube (CRT) or a liquid crystal display (LCD), or plasma screen or printer for presenting text or images, and a pointing device 1216, such as a mouse or a trackball or cursor direction keys, or motion sensor, for controlling a position of a small cursor image presented on the display 1214 and issuing commands associated with graphical elements presented on the display 1214. In some embodiments, for example, in embodiments in which the computer system 1200 performs all functions automatically without human input, one or more of external input device 1212, display device 1214 and pointing device 1216 is omitted.

In the illustrated embodiment, special purpose hardware, such as an application specific integrated circuit (ASIC) 1220, is coupled to bus 1210. The special purpose hardware is configured to perform operations not performed by processor 1202 quickly enough for special purposes. Examples of application specific ICs include graphics accelerator cards for generating images for display 1214, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1200 also includes one or more instances of a communications interface 1270 coupled to bus 1210. Communication interface 1270 provides a one-way or two-way communication coupling to a variety of external devices that operate with their own processors, such as printers, scanners and external disks. In general the coupling is with a network link 1278 that is connected to a local network 1280 to which a variety of external devices with their own processors are connected. For example, communication interface 1270 may be a parallel port or a serial port or a universal serial bus (USB) port on a personal computer. In some embodiments, communications interface 1270 is an integrated services digital network (ISDN) card or a digital subscriber line (DSL) card or a telephone modem that provides an information communication connection to a corresponding type of telephone line. In some embodiments, a communication interface 1270 is a cable modem that converts signals on bus 1210 into signals for a communication connection over a coaxial cable or into optical signals for a communication connection over a fiber optic cable. As another example, communications interface 1270 may be a local area network (LAN) card to provide a data communication connection to a compatible LAN, such as Ethernet. Wireless links may also be implemented. For wireless links, the communications interface 1270 sends or receives or both sends and receives electrical, acoustic or electromagnetic signals, including infrared and optical signals, that carry information streams, such as digital data. For example, in wireless handheld devices, such as mobile telephones like cell phones, the communications interface 1270 includes a radio band electromagnetic transmitter and receiver called a radio transceiver. In certain embodiments, the communications interface 1270 enables connection to the public data network for managing a sensor network.

The term computer-readable medium is used herein to refer to any medium that participates in providing information to processor 1202, including instructions for execution. Such a medium may take many forms, including, but not limited to, non-volatile media, volatile media and transmission media. Non-volatile media include, for example, optical or magnetic disks, such as storage device 1208. Volatile media include, for example, dynamic memory 1204. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 1220.

Network link 1278 typically provides information communication using transmission media through one or more networks to other devices that use or process the information. For example, network link 1278 may provide a connection through local network 1280 to a host computer 1282 or to equipment 1284 operated by an Internet Service Provider (ISP). ISP equipment 1284 in turn provides data communication services through the public, world-wide packet-switching communication network of networks now commonly referred to as the Internet 1290. A computer called a server host 1292 connected to the Internet hosts a process that provides a service in response to information received over the Internet. For example, server host 1292 hosts a process that provides information representing video data for presentation at display 1214.

At least some embodiments of the invention are related to the use of computer system 1200 for implementing some or all of the techniques described herein. According to one embodiment of the invention, those techniques are performed by computer system 1200 in response to processor 1202 executing one or more sequences of one or more processor instructions contained in memory 1204. Such instructions, also called computer instructions, software and program code, may be read into memory 1204 from another computer-readable medium such as storage device 1208 or network link 1278. Execution of the sequences of instructions contained in memory 1204 causes processor 1202 to perform one or more of the method steps described herein. In alternative embodiments, hardware, such as ASIC 1220, may be used in place of or in combination with software to implement the invention. Thus, embodiments of the invention are not limited to any specific combination of hardware and software, unless otherwise explicitly stated herein.

The signals transmitted over network link 1278 and other networks through communications interface 1270, carry information to and from computer system 1200. Computer system 1200 can send and receive information, including program code, through the networks 1280, 1290 among others, through network link 1278 and communications interface 1270. In an example using the Internet 1290, a server host 1292 transmits program code for a particular application, requested by a message sent from computer 1200, through Internet 1290, ISP equipment 1284, local network 1280 and communications interface 1270. The received code may be executed by processor 1202 as it is received, or may be stored in memory 1204 or in storage device 1208 or other non-volatile storage for later execution, or both. In this manner, computer system 1200 may obtain application program code in the form of signals on a carrier wave.

Various forms of computer readable media may be involved in carrying one or more sequence of instructions or data or both to processor 1202 for execution. For example, instructions and data may initially be carried on a magnetic disk of a remote computer such as host 1282. The remote computer loads the instructions and data into its dynamic memory and sends the instructions and data over a telephone line using a modem. A modem local to the computer system 1200 receives the instructions and data on a telephone line and uses an infra-red transmitter to convert the instructions and data to a signal on an infra-red carrier wave serving as the network link 1278. An infrared detector serving as communications interface 1270 receives the instructions and data carried in the infrared signal and places information representing the instructions and data onto bus 1210. Bus 1210 carries the information to memory 1204 from which processor 1202 retrieves and executes the instructions using some of the data sent with the instructions. The instructions and data received in memory 1204 may optionally be stored on storage device 1208, either before or after execution by the processor 1202.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. An apparatus comprising:
at least one processor; and
at least one memory including computer program code for one or more programs, the at least one memory and the computer program code configured to, with the at least one processor, cause the apparatus to perform at least the following:
detect an initialization of at least one dongle, the dongle configured to initiate pairing of the apparatus to at least one sensor;
identify the at least one sensor based, at least in part, on the pairing; and
initiate collection of data via the at least one sensor based, at least in part, on the identification.

2. An apparatus of claim 1, wherein the apparatus is further caused to:
determine pairing authentication information from the at least one dongle, the at least one sensor, or a combination thereof,
wherein the pairing of the apparatus of the at least one dongle is based, at least in part, on the pairing authentication information.

3. An apparatus of claim 1, wherein the apparatus is further caused to:
determine a status of the initialization, the pairing, the collection of the data, or a combination thereof; and
indicate the status via the dongle, the sensor, the apparatus, or a combination thereof.

4. An apparatus of claim 1, wherein the apparatus is further caused to:
determine configuration information for the at least one sensor from a backend platform,
wherein the collection of the data is based, at least in part, on the configuration information.

5. An apparatus of claim 1, wherein the apparatus is further caused to:
initiate transmission of the data to a backend platform concurrently with or after the collection of the data.

6. An apparatus of claim 1, wherein the apparatus is further caused to:
receive a request from a user for access all or a portion of the data, the request including user information; and
authenticate the access based, at least in part, on the user information.

7. An apparatus of claim 6, wherein the user information is obtained from a near field communication (NFC) tag.

8. An apparatus of claim 1, wherein the apparatus is further causing to:
initiate a communication session for discussion of the data.

9. An apparatus of claim 1, wherein the at least one sensor includes a health sensor, an environmental sensor, or a combination thereof.

10. An apparatus of claim 1, wherein the pairing is over a wireless connection.

11. A method comprising:
detecting an initialization of at least one dongle, the dongle configured to initiate pairing of an apparatus to at least one sensor;
identifying the at least one sensor based, at least in part, on the pairing; and
initiating collection of data via the at least one sensor based, at least in part, on the identification.

12. A method of claim 11, further comprising:
determining pairing authentication information from the at least one dongle, the at least one sensor, or a combination thereof,
wherein the pairing of the apparatus of the at least one dongle is based, at least in part, on the pairing authentication information.

13. A method of claim 11, further comprising:
determining a status of the initialization, the pairing, the collection of the data, or a combination thereof; and
indicating the status via the dongle, the sensor, the apparatus, or a combination thereof.

14. A method of claim 11, further comprising:
determining configuration information for the at least one sensor from a backend platform,
wherein the collection of the data is based, at least in part, on the configuration information.

15. A method of claim 11, further comprising:
initiating transmission of the data to a backend platform concurrently with or after the collection of the data.

16. A method of claim 11, further comprising:
receiving a request from a user for access all or a portion of the data, the request including user information; and
authenticating the access based, at least in part, on the user information.

17. A method of claim 16, wherein the user information is obtained from a near field communication (NFC) tag.

18. A method of claim 11, further comprising:
initiating a communication session for discussion of the data.

19. A method of claim 11, wherein the at least one sensor includes a health sensor, an environmental sensor, or a combination thereof.

20. A method of claim 11, wherein the pairing is over a wireless connection.
